(19) United States
(12) Patent Application Publication
(10) Pub. No.: US 2024/0122123 A1
(43) Pub. Date: Apr. 18, 2024

(54) AGRICULTURAL HARVESTING AND DRYING SYSTEM

(71) Applicant: RACKT LLC., Port Orange, FL (US)

(72) Inventor: Daniel B. Smith, JR., PORT ORANGE, FL (US)

(21) Appl. No.: 18/471,286

(22) Filed: Sep. 20, 2023

Related U.S. Application Data
(60) Provisional application No. 63/376,383, filed on Sep. 20, 2022.

(51) Int. Cl. A01F 25/12

(52) U.S. Cl. CPC A01F 25/12

(57) ABSTRACT

The invention disclosed herein relates to devices and systems used to grow, trellis, harvest and retain harvested plant material in a position that facilitates drying or curing the plant material. The devices and systems disclosed herein can be used to harvest and relocate plant material from growing areas to drying and/or curing areas more efficiently.

### CROSS-REFERENCE TO RELATED APPLICATIONS

The present application claims priority to U.S. Provisional Application Ser. No. 63/76,383 filed on Sep. 20, 2022, which is hereby incorporated by reference in its entirety.

### TECHNICAL FIELD OF THE INVENTION

The invention disclosed herein relates to devices and systems used to grow, harvest and retain harvested plant material in a position that facilitates drying or curing the plant material.

### BACKGROUND TO THE INVENTION

Dried and/or cured plant material is an important commodity in several industries. Plant material that requires or benefits from drying and/or curing include tobacco, cannabis, herbs, spices, and hops, along with many other agriculturally grown products to name a few. Common methods of drying such plant material may utilize improvised rack systems, clothesline type systems, wire hangers, or shelving not specifically designed for drying harvested plant material.

Known devices for transporting plant material for drying and/or curing and attaching or hanging plant material for drying and/or curing are not entirely satisfactory for the range of applications for which they are employed. For example, existing devices and methods make it cumbersome, difficult and time consuming to harvest plants and then attach and secure the plant material to the drying rack. Furthermore, conventional multi-step methods of drying and/or curing may result in damage to the plant material from excessive handling during transport of the plant material or the racks. In addition, conventional drying apparatuses and systems may not make efficient use of the drying area. Overall, the typical methods for room clearing and plant material transport are outdated and not efficient.

There exists a need for systems for harvesting, transporting, attaching, drying and/or curing plant material that improve upon and advance the designs of known devices.

### SUMMARY OF THE INVENTION

The invention disclosed herein relates to devices and systems for harvesting, transporting, attaching, drying and/or curing plant material. In some embodiments, the devices and systems disclosed herein include a rack portion having a substantially rigid frame and a perimeter with a net secured to the perimeter of the substantially rigid frame and a mounting portion including a means for removably attaching the rack portion in a plane above and parallel/horizontal to the plane of an area of plant growth.

In some embodiments, the rack portion further includes a stabilization bar. In some embodiments, the area of plant growth includes one or more grow tables. In some embodiments, the mounting portion includes a lower mount or table mount for receiving a pole, a pole, and an upper mount or rack mount, wherein the lower mount is capable of securing a pole perpendicular to the area of plant growth, and wherein the upper mount is capable of removably securing the rack portion to the pole at a height above the area of plant growth.

In some embodiments, the rack portion includes a securing means for hanging the rack portion vertically from a transport system. In some embodiments, the transport system includes a means for moving the rack portion along a floor or a track system. In some embodiments, the transport system includes a scale for weighing one or more plants attached to the rack portion and/or a RFID scanning system to scan one or more plants attached to the rack portion.

In some embodiments, methods of harvesting, transporting, attaching, drying and/or curing plant material are disclosed herein. In some embodiments, the method includes removably securing a rack having a substantially rigid frame and a perimeter with a net secured to the perimeter of the substantially rigid frame in a plane above and parallel (or horizontal) to an area of plant growth, permitting one or more plants to grow through the net, cutting the base of the one or more plants below the plane of the rack; and removing the rack with the one or more plants grown through the net.

In some embodiments, the method includes hanging the rack vertically to allow the one or more plants grown through the net to dry and/or cure. In some embodiments, the method includes attaching the rack with the one or more plants grown through the net to a transport system comprising a means for moving the rack along a floor or a track system.

### BRIEF DESCRIPTION OF THE DRAWINGS

FIG. 1 is a front view of an embodiment of the rack portion of the system described herein.

FIG. 2 is a front view of an embodiment of the rack portion of the system described herein in an unassembled state.

FIG. 3A is a front view of an embodiment of the transport system described herein. FIG. 3B is a front view of an embodiment showing three transport systems nested together.

FIGS. 4 and 5 are front views of an embodiment of the transport system described herein.

FIG. 6 is a view of the mounting portion of the system described herein.

FIGS. 7 and 8 are back and front views of an embodiment of a table mount described herein.

FIGS. 9 and 10 are front and back views of an embodiment of a table mount described herein.

FIGS. 11 and 12 are front and back views of an embodiment of a table mount described herein.

FIGS. 13 and 14 are front and back views of an embodiment of a table mount described herein.

FIGS. 15 and 16 are perspective views of an embodiment of a rack mount described herein.

FIG. 17 is a perspective view of an embodiment of a rack mount described herein.

FIGS. 18 and 19 are perspective views of an embodiment of a rack mount described herein.

FIG. 20 is a view of the rack portion and mounting portion secured to a grow table in use.

### DETAILS OF INVENTION

The system for plant trellising, plant harvesting and drying or curing disclosed herein will become better understood through review of the following detailed description and in conjunction with the figures. The detailed description and figures provide merely an example of the invention described herein. Those skilled in the art will understand that the disclosed examples may be varied, modified, and altered without departing from the scope of the invention described herein. Many variations are contemplated for different application and design considerations; however, for the sake of brevity, each contemplated variation is not individually described in the following detailed description.

Throughout the following detailed description, a variety of examples of devices for trellising, harvesting, attaching, transporting, drying and/or curing plant material are provided. Related features in the examples may be identical, similar, or dissimilar in different examples. For the sake of brevity, related features will not be redundantly explained in each example. Instead, the use of related feature names will cue the reader that the feature with a related feature name can be similar to the related feature in an example explained previously. Features specific to a given example will be described in that example. The reader should understand that a given feature need not be the same or similar to the specific portrayal of a related feature in any given figure or example.

Embodiments of the invention disclosed herein relate to devices and/or systems for trellising, harvesting, attaching, transporting, drying and/or curing plant material. In some embodiments, the devices and/or systems include a rack portion, wherein the rack portion includes a substantially rigid frame having a perimeter and netting secured to the perimeter of the frame, and a mounting portion, wherein the mounting portion provides a means for removably attaching the rack portion to a grow area. In some embodiments, the grow area is a grow table. In some embodiments, the devices and/or systems further include a transport system to which the rack portion can be removably attached to relocate the rack from the grow area to a drying or curing area. In some embodiments, the system further includes transport system including, for example, a rail, a track, a cart, and the like. In some embodiments, the transport system further includes a weighing station and/or a RFID scanning system.

The devices and/or systems disclosed herein address many shortcomings existing with conventional plant harvest, transport and drying and/or curing methods and devices. For example, the devices and/or systems disclosed herein result in significant efficiencies in harvesting and transporting plant material from a grow area (e.g., a grow table) to a drying or curing area. In some embodiments, utilizing the devices and/or systems disclosed herein saves considerable amounts of time, labor and physical stress on staff.

In addition, the devices and/or systems disclosed herein eliminate the cumbersome process of attaching harvested plants one-at-a-time to a drying rack. The devices and/or systems described herein allow for plant material to be harvested and removed from a grow area (e.g., a grow table) at once in bulk, while remaining attached to the rack portion via the netting, without the need to attach the harvested plants individually to a drying rack. In use, the plant material having grown through the netting of the rack portion is simply clipped at its base allowing for all the plant material that has grown through the netting to remain attached after being clipped, to be taken away at once; instead of the typical method of clipping each plant individually, removing the harvested plant material from the grow area, and then attaching each plant separately to a drying rack one by one in the drying, curing area.

In addition, the devices and/or systems disclosed herein provide an efficient and easy way to transport heavy plant material from the grow area to the drying or curing area by removably attaching the rack portion to a transport system. Still further, the devices and/or systems disclosed herein maximize drying and/or curing space by vertically hanging the plant material from the rack portion. In some embodiments, the devices and/or systems are modular, allowing multiple rack portions to be placed next to one another, side-by-side, and/or in tight rows, to make efficient use of the drying or curing space. Finally, the devices and/or systems disclosed herein allow for much more efficient harvesting and clearing of a grow area and relocating the harvested plant material to a drying and/or curing area.

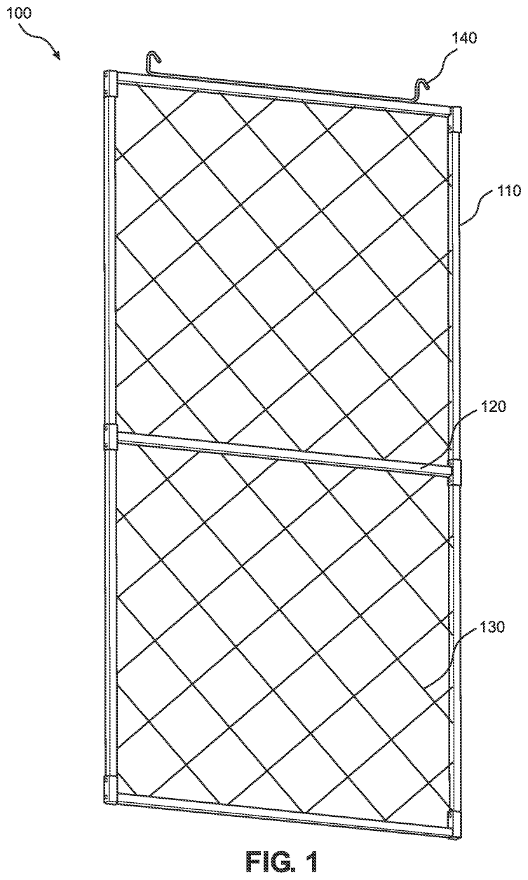

As shown in FIG. 1, an exemplary rack portion 100 can include a rectangular frame 110 with one or more stabilization bars 120 to stabilize the frame. Netting 130 can be secured to entire perimeter of the frame. The frame 110 further includes one or more securing means 140, such as hooks, to removably attach the rack portion 100 to a transport system and hanging apparatus in drying and curing room.

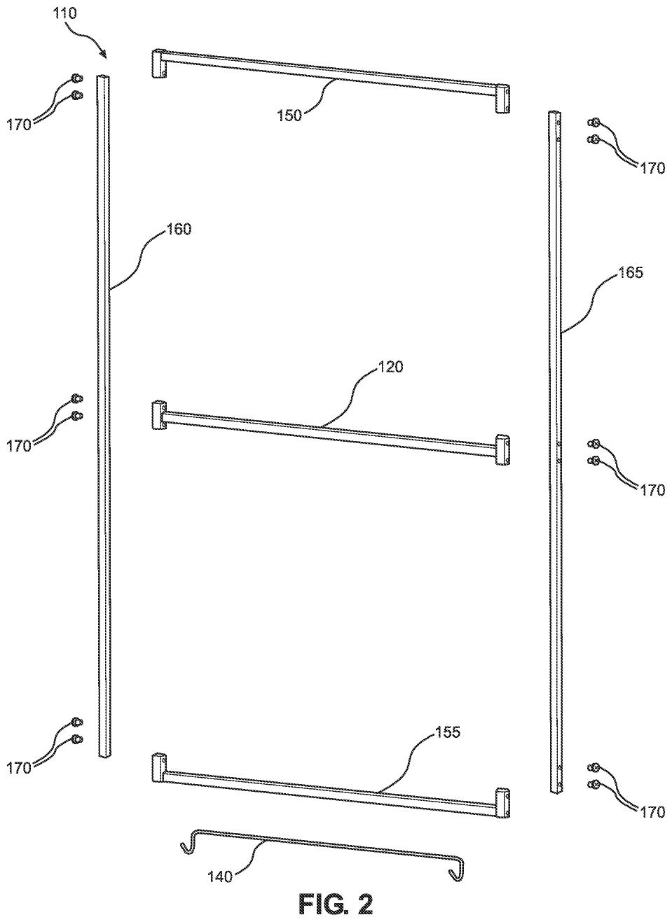

In some embodiments, the rack portion 100 is welded together. As shown in FIG. 2, in some embodiments. The rack portion 110 is provided unassembled in a kit to be assembled and secured with one or more fastening means 170. For example, in some embodiments, the rack portion 100 is provided as a top bar 150, lower bar 155, sides 160 and 165, stabilization bar 120, securing means 140, and one or more fastening means 170. In some embodiments, the one or more fastening means 170 are screws or rivets, and the like. In some embodiments, the rack portion 110 is provided with instructions and optionally with tools for assembly.

In some embodiments, the size and shape of the frame 110 is fitted to coincide with the size and shape of a grow table. In some embodiments, the perimeter of the frame of the rack portion is substantially square, or substantially rectangular. In some embodiments, the dimensions of the frame 110 are about 1 foot by 4 feet, or about 1 foot by 8 feet, or about 2 feet by 2 feet, or about 2 feet by 4 feet, or about 2 feet by 5 feet, or about 2 feet by 7 feet, or about 2 feet by 8 feet, or about 2 feet by 10 feet, or about 3 feet by 3 feet, or about 3 feet by 6 feet, or about 3 feet by 7 feet, or about 3 feet by 8 feet, or about 3 feet by 10 feet, or about 4 feet by 4 feet, or about 4 feet by 5 feet, or about 4 feet by 6 feet, or about 4 feet by about 7 feet, or about 4 feet by 8 feet, or about 4 feet by 9 feet, or about 4 feet by 10 feet or about 5 feet by 5 feet, or about 5 feet by about 7 feet, or about 5 feet by about 8 feet, or about 5 feet by about 9 feet, or about 5 feet by 10 feet, and the like.

In some embodiments, grow tables vary from about 3 feet wide to about 5 feet wide and from about 4 feet long to 60+ feet long, or considerably longer if growing outside or in greenhouses. Thus, in some embodiments, the size and shape of the frame 110 is fitted to coincide with sections of the length of the grow tables. For example, in some embodiments, the size and shape of the frame 110 is fitted to coincide with 3-foot sections, 4-foot sections, 5-foot sections, 6-foot sections, 7-foot sections, 8-foot sections, or 9-foot sections of the length of the grow table.

In some embodiments, depending on the plant size, each four (4) feet of table length includes roughly 5 to 25, or 7 to 23, or 9 to 21, or 11 to 19, or 13 to 17 plants per section. In some embodiments, depending on the plant size, each four (4) feet of table length includes roughly 10 to 30, or 12 to 28, or 14 to 26, or 16 to 24, or 18 to 22 plants per section. In some embodiments, depending on the plant size, each four (4) feet of table length includes roughly 7 to 17, or 8 to 16, or 9 to 15, or 10 to 14, or 11 to 13 plants per section. In some embodiments, depending on the plant size, each four (4) feet of table length includes roughly 11 to 13 plants per section and each eight (8) feet of table length includes roughly would add on roughly 22 to 26 plants per section.

In some embodiments, the frame 110 can be constructed from material such as, but not limited to, steel, steel alloy, stainless steel, corrugated steel, galvanized steel, iron, cast iron, aluminium and its alloys, titanium and its alloys, copper and its alloys, nickel and its alloys, brass, cobalt, other metals, plastic, molded plastics, polyvinyl chloride (PVC or vinyl), wood and the like.

In some embodiments, the rack portion further includes one or more stabilization bars 120 to stabilize the perimeter of the frame 110. In some embodiments, the one or more stabilization bars 120 can be constructed from material such as, but not limited to, steel, steel alloy, stainless steel, corrugated steel, galvanized steel, iron, cast iron, aluminium and its alloys, titanium and its alloys, copper and its alloys, nickel and its alloys, brass, cobalt, other metals, plastic, molded plastics, polyvinyl chloride (PVC or vinyl), wood, and the like.

In some embodiments, the one or more stabilization bars 120 are located diagonally across one or more angles or corners of the frame. In some embodiments, the one or more stabilization bars are located diagonally across every angle or corner of the frame. In some embodiments, the one or more stabilization bars are located horizontally across the frame. In some embodiments, the one or more stabilization bars are located vertically across the frame. In some embodiments, the one or more stabilization bars pass through the center of the frame.

In some embodiments, the one or more stabilization bars 120 can be in various arrangements such as, for example, but not limited to, single horizontal, dual horizontal, triple horizontal, quadruple horizontal, quintuple horizontal, sextuple horizontal, septuple horizontal, octuple horizontal, nonuple horizontal, decuple horizontal, single vertical, dual vertical, triple vertical, quadruple vertical, quintuple vertical, sextuple vertical, septuple vertical, octuple vertical, nonuple vertical, decuple vertical, single diagonal, dual diagonal, triple diagonal, quadruple diagonal, quintuple diagonal, sextuple diagonal, septuple diagonal, octuple diagonal, nonuple diagonal, decuple diagonal, and the like.

In some embodiments, the frame 110 can have corner supports (not shown) in each corner or only some corners for stabilization in various shapes such as, for example, but not limited to a triangle, a square, a rectangle, and the like.

In some embodiments, the netting 130 is secured to substantially the entire perimeter of the frame 110. In some embodiments, the netting 130 is secured to the entire perimeter of the frame 110. The netting size and configuration is selected such that the plants are able to grow through the netting but the entire plant (e.g., all branches), does not pass through a single opening in the netting.

In some embodiments, the netting 130 can be constructed from material such as, but not limited to, rope, natural manila rope, promanila rope, poly dacron rope, nylon rope, polypropylene rope, webbing, polyester webbing, polypropylene webbing, nylon webbing, netting, plastic extruded mesh netting, plastic oriented mesh netting, knitted mesh netting, polypropylene mesh netting, nylon mesh netting, polyethylene netting, wire rope, and the like.

In some embodiments, the netting 130 can have holes in shapes such as, but not limited to, squares, rectangles, diamonds, circles, hexagons, octagons, triangles, and the like.

In some embodiments, the netting 130 can have opening sizes and dimensions approximately, but not limited to, about 1 inch×1 inch, or about 1 inches×2 inches, or about 1 inch×3 inches, or about 1 inch×4 inches, or about 1 inch×5 inches, or about 1 inch×6 inches, or about 1 inch×7 inches, or about 1 inch×8 inches, or about 1 inch×9 inches, or about 1 inch×10 inches, or about 1 inch×11 inches, or about 1 inch×12 inches, or about 2 inches×2 inches, or about 2 inches×3 inches, or about 2 inches×4 inches, or about 2 inches×5 inches, or about 2 inches×6 inches, or about 2 inches×7 inches, or about 2 inches×8 inches, or about 2 inches×9 inches, or about 2 inches×10 inches, or about 2 inches×11 inches, or about 2 inches×12 inches, or about 3 inches×3 inches, or about 3 inches×4 inches, or about 3 inches×5 inches, or about 3 inches×6 inches, or about 3 inches×7 inches, or about 3 inches×8 inches, or about 3 inches×9 inches, or about 3 inches×10 inches, or about 3 inches×11 inches, or about 3 inches×12 inches, or about 4 inches×4 inches, or about 4 inches×5 inches, or about 4 inches×6 inches, or about 4 inches×7 inches, or about 4 inches×8 inches, or about 4 inches×9 inches, or about 4 inches×10 inches, or about 4 inches×11 inches, or about 4 inches×12 inches, or about 5 inches×5 inches, or about 5 inches×6 inches, or about 5 inches×7 inches, or about 5 inches×8 inches, or about 5 inches×9 inches, or about 5 inches×10 inches, or about 5 inches×11 inches, or about 5 inches×12 inches, or about 6 inches×6 inches, or about 6 inches×7 inches, or about 6 inches×8 inches, or about 6 inches×9 inches, or about 6 inches×10 inches, or about 6 inches×11 inches, or about 6 inches×12 inches, or about 7 inches×7 inches, or about 7 inches×8 inches, or about 7 inches×9 inches, or about 7 inches×10 inches, or about 7 inches×11 inches, or about 7 inches×12 inches, or about 8 inches×8 inches, or about 8 inches×9 inches, or about 8 inches×10 inches, or about 8 inches×11 inches, or about 8 inches×12 inches, or about 9 inches×9 inches, or about 9 inches×10 inches, or about 9 inches×11 inches, or about 9 inches×12 inches, or about 10 inches×10 inches, or about 10 inches×11 inches, or about 10 inches×12 inches, or about 11 inches×11 inches, or about 11 inches×12 inches, or about 12 inches×12 inches, or more.

In some embodiments, the rack portion 100 further includes one or more hooks 140 or other similar securing means on one or more sides of the perimeter of the frame 110 to removably attach the rack portion to a transport system and/or to otherwise hang the apparatus in a drying and/or curing room. In some embodiments, the securing means can be, for example, but not limited to, clips, threaded shafts, threaded hooks, welded hooks, protrusions, screws, riveted and the like.

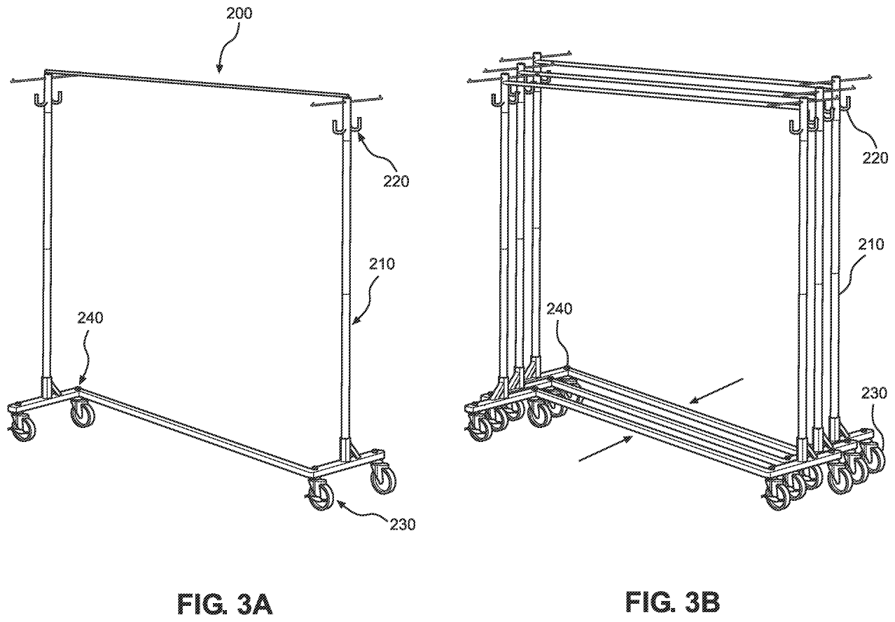

As shown in FIGS. 3A and 3B, in some embodiments, the system disclosed herein further includes a transport system 200 including a frame 210, one or more attaching means 220 for removably attaching the securing means 140 of the rack portion 100, and wheels 210, wherein the transport system 200 provides a means for transporting the rack portion 100 from one area to another, such as from a grow area to a drying and/or curing area. In some embodiments, the rack portion 100 is transported by rolling the transport system 200 on the floor. In some embodiments, the hanging frame 210 of the transport system 200 includes a Z-base design 240 for increased stability and maximum space saving.

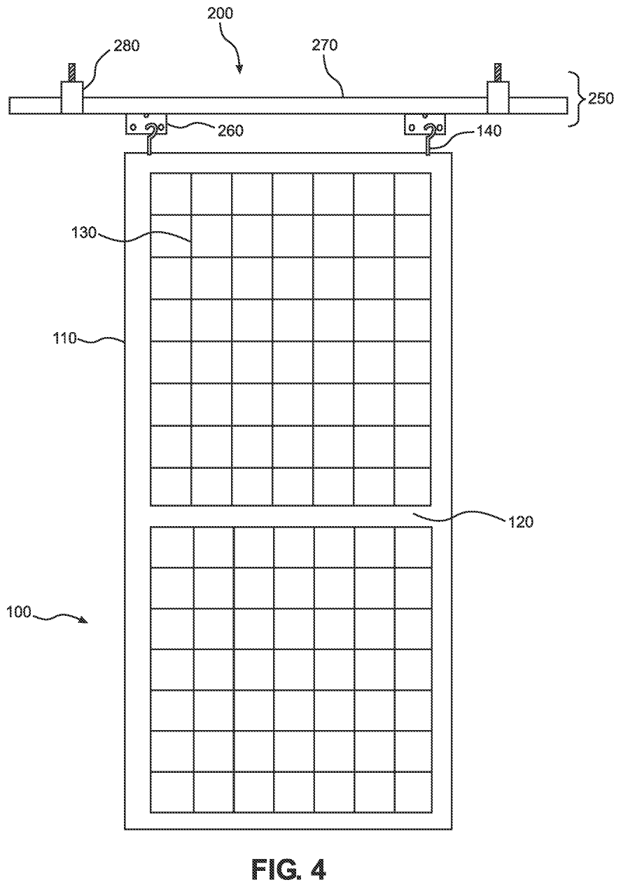

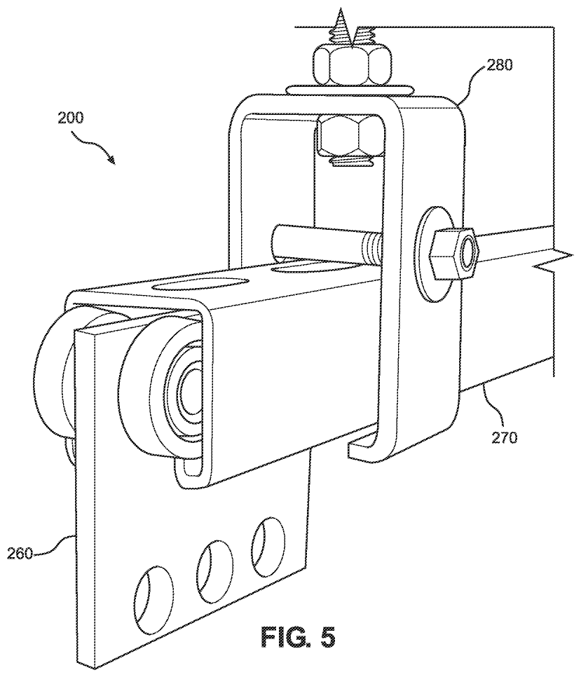

As shown in FIGS. 4 and 5, in some embodiments, the transport system 200 includes a trolley and track system 250 whereby the securing means 140 of the rack portion 100 can be removably attached to a trolley 260 moveable along a track 270, wherein the track 270 is secured by a securing means 280 to a ceiling thereby allowing the rack portion 100 to be moved along the track 270. In some embodiments, the transport system includes an airline trolley system. In some embodiments, the track system 250 is an airline trolley system, or the like. In some embodiments, the rack portion 100 is mounted to the transport system using the securing means 140, such as by attaching the securing means 140 to the track system 250, such as a ceiling airline and trolley system, thereby allowing for attachment and vertical hang of the rack portion 100 during the curing and/or drying process.

In some embodiments, the transport system 200 is capable of weighing and/or recording the harvested plants into a compliance or tracking system prior to, during, or after transport of the plants from a grow room into a dry room. For example, in some embodiments, the transport system 200 further includes a scale from which the rack portion 100 is hung. In some embodiments, the scale includes an RFID scanner to scan every plant when the rack portion 100 is hung from the scale. In some embodiments, the scale and/or RFID scanner includes an API that communicates with a compliance/tracking system that in real time records the actual plants on the rack and/or the total weight of the rack portion 100 and harvested plants on the transport system 200. In some embodiments, the weight of the rack portion 100 is subtracted from the total weight to obtain a total plant weight, which is then divided by the total plant count to obtain an average per plant. In some embodiments, the average per plant weight is recorded in a compliance tracking software. The inclusion of a scale and/or RFID scanner in the transport system 200 eliminates the steps of having to stop at a hanging scale as well as recording/inputting plants and plant weights into a compliance/tracking system, further reducing time and increasing efficiency of the harvesting process.

In some embodiments, the rack portion 100 remains on the transport system 200 during the drying and/or curing process. In some embodiments, the rack portion 100 is removed from the transport system 200 after transport and hung elsewhere for the drying and/or curing process, such as from a ceiling or from a wall hanger.

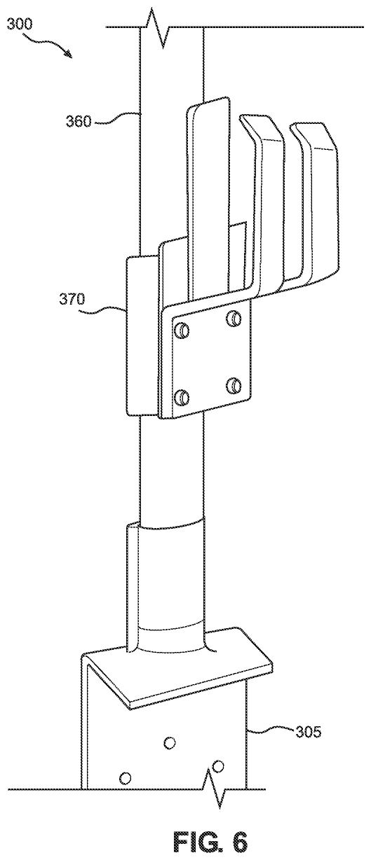

In some embodiments, as shown in FIG. 6, the system disclosed herein includes a mounting portion 300, which includes one or more poles 360, one or more rack mounts (or top mounts) 370, and one or more table mounts (or bottom mounts) 305. In some embodiments, the one or more table mounts 305 is configured to securely, but removably, attach by an attaching means to a grow area (e.g., a grow table), and securely, but removably secure a pole 360 to the grow area. The one or more rack mounts 370 are configured to securely, but removably, attach to a pole 360 and securely, but removably, attach the rack portion 100 to the pole 360 at a predetermined height.

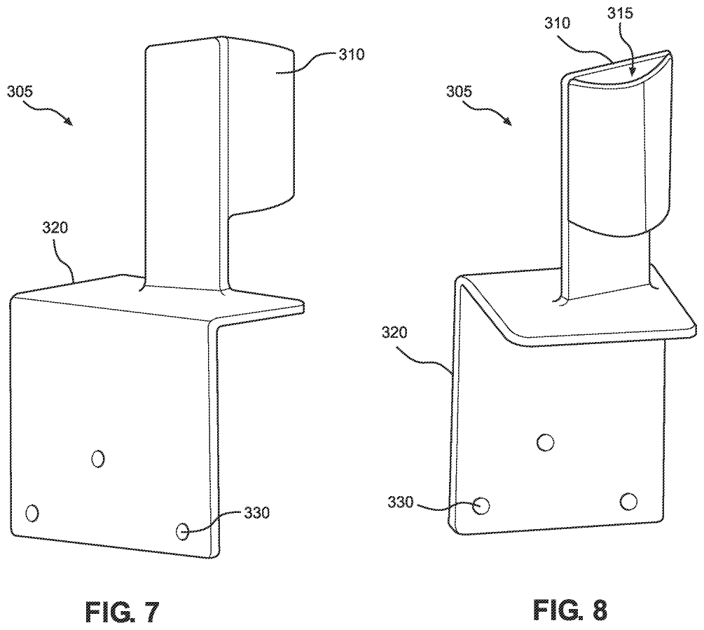

In some embodiments, as shown in FIGS. 7 and 8, the table mount 305 includes a pole holder 310 having an opening 315 for receiving a pole, wherein the pole holder 310 is fixed to a base 320 is a single piece molded or welded together. The table mount 305 further includes one or more means for removably attaching 330 the table mount to a grow area such as a grow table.

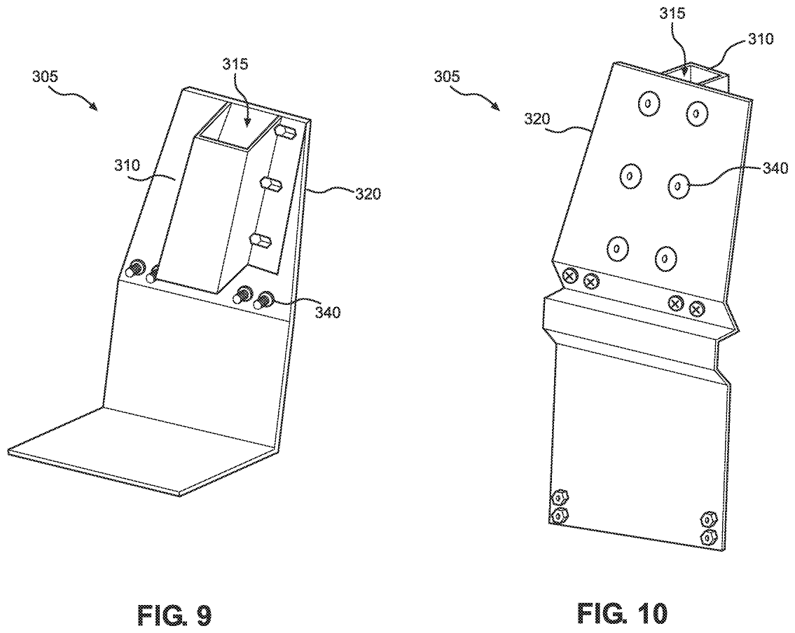

In some embodiments, as shown in FIGS. 9 and 10 the table mount 305, which includes a pole holder 310 having an opening 315 for receiving a pole fixed to a base 320, is two or more pieces held together by screws or rivets or other similar fastening means 340. In some embodiments, the base 320 attaches to the grow area (e.g., a grow table) by one or more screws or rivets, or other similar attaching means 330.

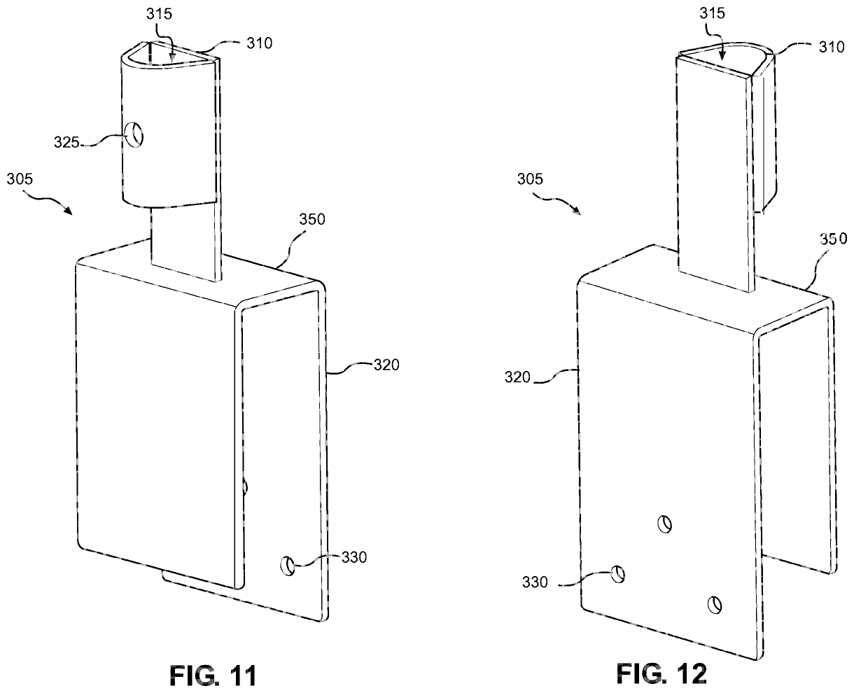

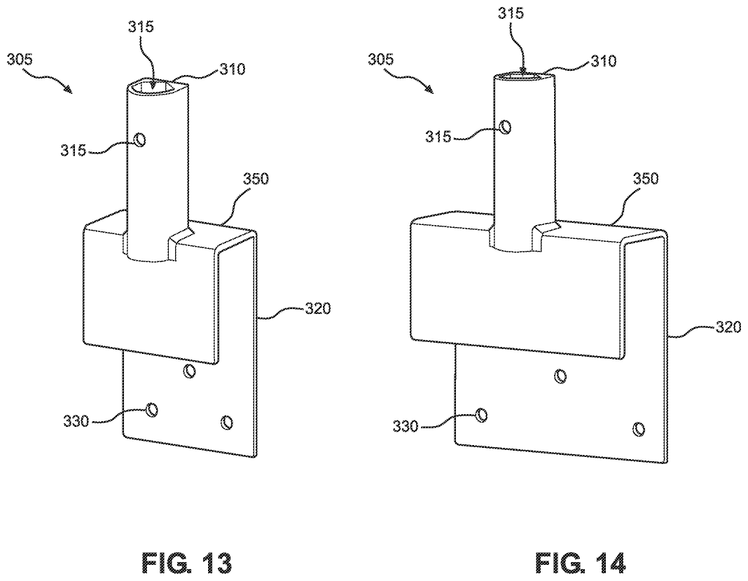

In some embodiments, as shown in FIGS. 11-14, the table mount 305 includes a pole holder 310 having an opening for receiving a pole 315 which is attached to a U-shaped base 350 that attaches to a grow area (e.g., a grow table). In some embodiments, the pole holder 310 includes an aperture 325 for receiving a means for securing the pole 360 in the pole holder 310. In some embodiments, the means for securing the pole in the pole holder can be, for example, but not limited to, a screw that can be tightened against the pole.

In some embodiments, the pole holder 310 can be constructed from material such as, but not limited to, steel, steel alloy, stainless steel, corrugated steel, galvanized steel, iron, cast iron, aluminium and its alloys, titanium and its alloys, copper and its alloys, nickel and its alloys, brass, cobalt, other metals, plastic, molded plastics, polyvinyl chloride (PVC or vinyl), wood and the like.

In some embodiments, the one or more poles 360 have a substantially round perimeter. In some embodiments, the one or more poles 360 have a substantially square perimeter. In some embodiments, the one or more poles 360 have a substantially rectangular perimeter. In some embodiments, the one or more poles 360 are about ⅛ inch, or about ¼ inch, or about ⅜ inch, or about ½ inch, or about ⅝ inch, or about ¾ inch, or about ⅞ inch, or about 1 inch, or about 1⅛ inch, or about 1¼ inch, or about 1⅜ inch, or about 1½ inch, or about 1⅝ inch, or about 1¾ inch, or about 1⅞ inch, or about 2 inch, or about 2⅛ inch, or about 2′A inch, or about 2⅜ inch, or about 2½ inch, or about 2⅝ inch, or about 2¾ inch, or about 2⅞ inch, or about 3 inch in diameter. In some embodiments, the one or more poles 360 are about 1 foot, or about 1.5 foot, or about 2 feet, or about 2.5 feet, or about 3 feet, or about 3.5 feet, or about 4 feet, or about 4.5 feet, or about 5 feet, or about 5.5 feet, or about 6 feet, or about 6.5 feet, or about 7 feet, or about 7.5 feet, or about 8 feet or more in length.

In some embodiments, the one or more poles 360 can be constructed from material such as, but not limited to, steel, steel alloy, stainless steel, corrugated steel, galvanized steel, iron, cast iron, aluminium and its alloys, titanium and its alloys, copper and its alloys, nickel and its alloys, brass, cobalt, other metals, plastic, molded plastics, polyvinyl chloride (PVC or vinyl), wood, wooden dowels, and the like.

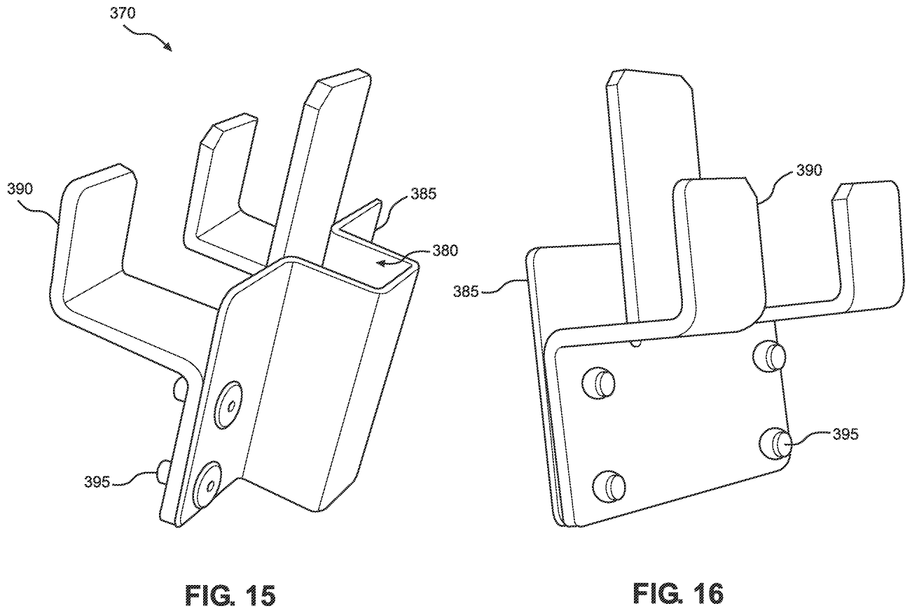

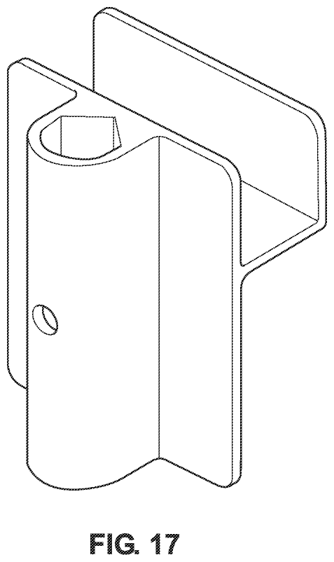

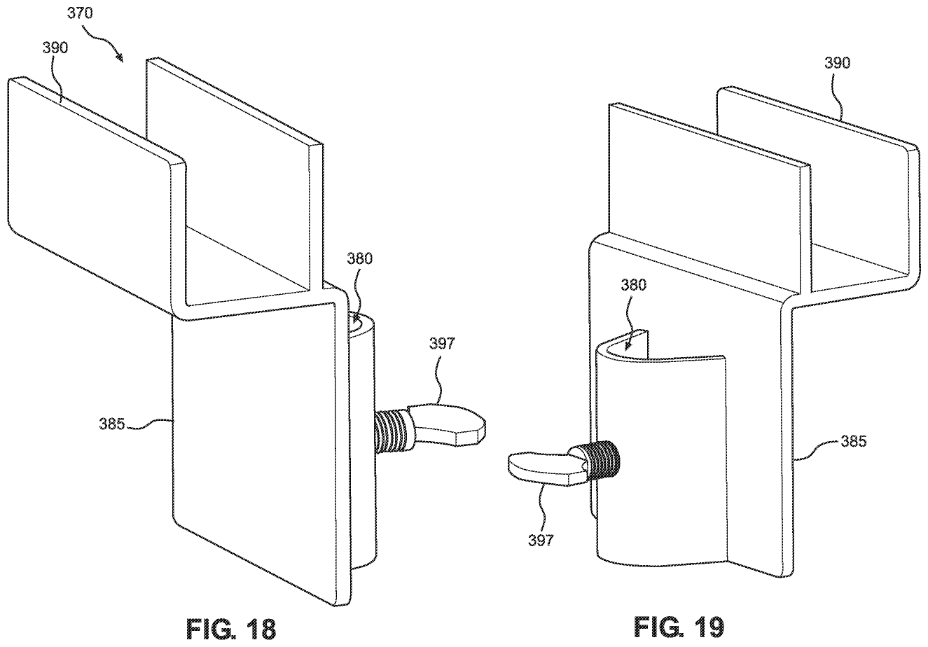

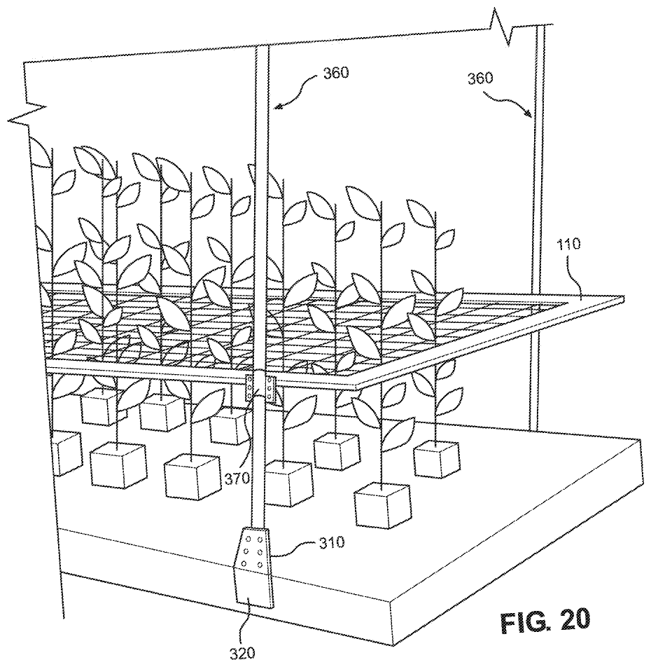

As show in in FIGS. 15-19, in some embodiments, the one or more rack mounts 370 include an opening 380 through which a pole 360 (not shown) can pass, wherein the opening is fixed to a base 385 having one or more arms 390 extending or protruding therefrom for receiving and removably securing to the frame 110 of the rack portion 100. In some embodiments, the opening 380 for receiving a pole fixed to a base 385 is a single piece molded or welded together. As shown in FIGS. 15 and 16, in some embodiments, the opening 380 for receiving a pole 360 (not shown) fixed to a base 385 is two or more pieces held together by screws or rivets or other similar securing means 395. In some embodiments, as shown in FIGS. 18 and 19, the one or more rack mounts 370 can be removably secured anywhere along the length of a pole 360 (not shown) by turning a screw or key 397 to tighten it against the pole 360 (not shown) thereby allowing the placement of the mounting clips 370 on the pole 360 (not shown) and adjustment to a desired location.

In some embodiments, the one or more rack mounts 370 can be constructed from material such as, but not limited to, steel, steel alloy, stainless steel, corrugated steel, galvanized steel, iron, cast iron, aluminium and its alloys, titanium and its alloys, copper and its alloys, nickel and its alloys, brass, cobalt, other metals, plastic, molded plastics, polyvinyl chloride (PVC or vinyl), wood and the like.

In use, the one or more table mounts 305 are secured to a grow area (e.g., a grow tables) at the base 320 and a pole 360 inserted upright into the pole holder 310 such that the one or more poles 360 are perpendicular to the plane of the grow area (e.g., grow table). The pole is passed through the opening 380 in a rack mount 370 and the rack mount adjusted to a desired height along the pole 360 from the grow area (e.g., grow table). Once the one or more rack mounts 370 are removably secured at the desired height from the grow area, the frame 110 of the rack portion 100 is removably attached to the one or more arms 390 of the one or more rack mounts 370, such that the plane of the rack portion 100 is parallel to the plane of the grow area (e.g., grow table). The desired height of the rack portion 100 above the grow table is determined based on the type of plant to allow the plant to grow through the netting 130 and become “locked” in the netting 130 from growth. In some embodiments, the rack portion 100 is placed about 2 inches, or about 3 inches, or about 4 inches, or about 5 inches, or about 6 inches, or about 8 inches, or about 10 inches, or about 12 inches, or about 14 inches, or about 16 inches, or about 18 inches, or about 20 inches, or about 22 inches, or about 24 inches, or about 26 inches, or about 28 inches, or about 30 inches, or about 32 inches, or about 34 inches, or about 36 inches, or about 38 inches, or about 40 inches, or about 42 inches, or about 44 inches, or about 46 inches, or about 48 inches, or about 50 inches or above the plane of the grow area (e.g., grow table).

After the rack portion 100 is secured, plants are permitted to grow through the netting 130 such that the plants become “locked” into the netting 130, for example, but not limited to, not all branches of a single plant pass through a single opening in the netting. In some embodiments, the netting 130 is selected such that a single mature plant passes through two or more openings in the netting 130. In some embodiments, each mature plant passes through three or more, or four or more, or five or more, or six or more openings in the netting 130.

Once the mature plants are ready to be harvested, the base of each plant is cut below the plane of the rack portion 100. In some embodiments, mature plants are cut at the lowest point above soil or media, or before any branching points. In some embodiments, mature plants are cut below a branching point having branches that pass through at least two openings of the netting 130.

Once the plants have been cut, the rack portion 100 is released from the one or more rack mounts 370 and the rack portion 100 with mature plants “locked” into the netting 130 removed from the grow area (e.g., grow table) and optionally removably attached to the transport system 200 to be moved to a drying or curing room.

### EXAMPLES

### Example 1

Trellising, Harvesting and drying systems including a rack portion and a mounting portion according to embodiments of the invention disclosed herein were prepared and utilized in a grow room. include a rack portion, wherein the rack portion includes a substantially rigid frame having a perimeter and netting secured to the perimeter of the frame, and a mounting portion, wherein the mounting portion provides a means for removably attaching the rack portion to a grow area.

Briefly, a forty (40) light room with six (6) rows 4′×32′ feet long made up of four (4) sections of 4×8 foot grow trays/tables per row was set up using four (4) trellising, harvesting and drying systems per row, 24 trellising, harvesting and drying systems total. Each row contained eighty-one (81) plants, planted on rock wool slabs, 6″×6″ rockwool unislabs or 1 gal coco pot with each 4′×8′ trellising, harvesting and drying system containing anywhere from twenty-two (22) to twenty-six (26) plants for a total of 440-520 plants.

Two (2) people harvested the entire room in two (2) hours for a total of four (4) labor hours. This included cutting the base of every plant, pulling the poles out of the table and setting them on the table, rotating the rack portion containing the harvested plants onto its side, taking the rack portion/plants out of the room, placing the rack portion/plants on the transport system, transporting the rack portion/plants to the hanging scale, hanging the rack portion/plants on the scale and weighing/recording compliance, removing the rack portion/plants from the hanging scale, transporting the rack portion/plants into the dry room, rotating the rack portion/plants such that the long end of the rack portion was vertical, hanging the rack portion/plants in the dry room, and repeating this process until all rack portions with plants were removed from grow room and relocated into the dry room.

This same size room would typically take a staff of six (6) to ten (10) people roughly eight (8) to twelve (12) hours for a total of forty-eight (48) to 120 labor hours to harvest. This includes cutting each plant out of the trellis, cutting each plant and weighing/recording compliance, placing each plant on a transport container/bin or rack (such as a garment rack), moving the harvested plants in groups of approximately 4-10 plants to the dry room where 2-4 people pull plants off/out of the transport container/bin or rack and hang them on a vertically hung trellis, netting, wire strung across the room, clothing rack, metal coat hanger, metal or aluminium garment hanger, plastic coat hanger, metal pallet, rack, shelving or the like. This prior art methods requires a large amount of staff, labor, resources and time as well as more touches on the product which in turn damages said product.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A device for harvesting plant material comprising:
a rack portion comprising a substantially rigid frame having a perimeter and a net secured to the perimeter of the substantially rigid frame;
a mounting portion comprising a means for removably attaching the rack portion in a plane above and parallel to an area of plant growth.

2. The device of claim 1, wherein the rack portion further comprises a stabilization bar.

3. The device of claim 1, wherein the area of plant growth comprises a grow table.

4. The device of claim 1, wherein the mounting portion comprises a lower mount for receiving a pole, a pole, and a rack mount, wherein the lower mount is capable of securing a pole perpendicular to the area of plant growth, and wherein the rack mount is capable of removably securing the rack portion to the pole at a height above the area of plant growth.

5. The device of claim 1, wherein the rack portion comprises a securing means for hanging the rack portion vertically from a transport system.

6. The device of claim 5, wherein the transport system comprises a means for moving the rack portion along a floor or a track system.

7. The device of claim 5, wherein the transport system comprises a scale for weighing one or more plants attached to the rack portion or a RFID scanning system to scan one or more plants attached to the rack portion.

8. A method of harvesting plant material comprising:
removably securing a rack comprising a substantially rigid frame having a perimeter and a net secured to the perimeter of the substantially rigid frame in a plane above and parallel to an area of plant growth;
permitting one or more plants to grow through the net;
cutting the base of the one or more plants below the plane of the rack;
removing the rack with the one or more plants grown through the net.

9. The method of claim 8, wherein the method comprises hanging the rack vertically to allow the one or more plants grown through the net to dry and/or cure.

10. The method of claim 8, wherein the method further comprises attaching the rack with the one or more plants grown through the net to a transport system comprising a means for moving the rack along a floor or a track system.
